(19) United States
(12) Patent Application Publication
(10) Pub. No.: US 2002/0104163 A1
(43) Pub. Date: Aug. 8, 2002

(54) Support device for an imaging medical examination apparatus and method for the operation thereof

(75) Inventor: Rolf Reimann, Forchheim (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 10/055,059

(22) Filed: Jan. 23, 2002

(30) Foreign Application Priority Data
Jan. 25, 2001 (DE) 10103331.1

(51) Int. Cl. A61G 7/00; A61G 13/00

(52) U.S. Cl. 5/601; 5/943

(57) ABSTRACT

In addition to a supporting unit at which a support plate is movably arranged, a support device for a medical examination imaging apparatus, particularly for a magnetic resonance apparatus or for a computed tomography apparatus, has a support at the opposite side of the medical examination apparatus. The support plate with an examination subject can be movably placed on the support after the support plate proceeds through opening of the medical examination apparatus for the acceptance of the examination subject. The support device also enables very good reproducibility of the examination results even with an extremely long scan length. The support is height-adjustable and may be extended upward after the support plate has been guided through the opening to a point above the support.

### BACKGROUND OF THE INVENTION

1. Field of the Invention

The invention is directed to a support device for a medical examination imaging apparatus, particularly for a magnetic resonance apparatus or for a computed tomography apparatus, wherein the examination apparatus has a through opening for the acceptance of an examination subject such as a patient. The invention is also directed to a method for the operation of such a support device.

2. Description of the Prior Art

In computed tomography apparatuses as well as in magnetic resonance apparatuses it is standard, for three-dimensional scanning of a patient, to scan the patient in a longitudinal direction. To this end, the patient is introduced into an opening of a gantry or into an opening of a housing that, for example, encloses a magnet, and the patient is conducted through this opening in steps or continuously until the region of the patient to be examined has been completely scanned. An exposure region or examination region is located in the opening, a two-dimensional, slice-like image or a spiral volume model being registered therein at every step.

German OS 42 24 036 discloses a patient support mechanism for this purpose.

For some examinations, for example for a trauma examination, it is necessary to implement a scan that covers the entire body of the patient. This should ensue without repositioning the patient. Known mechanisms have a support plate for the examination subject that, proceeding from one side of the opening, can be introduced in cantilevered fashion into the opening.

In the case of the aforementioned, extremely long scan lengths, such known support mechanisms are not adequately precise for numerous examinations. In the case of large scan lengths, such a support mechanism does not guarantee a good reproducibility of the examination results. This is especially disturbing when, for example in a monitoring examination after tumor therapy has been carried out, the region of the patient that has been treated is to be compared to an initial examination that ensued at a earlier time.

### SUMMARY OF THE INVENTION

An object of the present invention is to provide a support device that also assures a good reproducibility of the examination results in the case of an extremely long scan length. It is also an object to provide an operating method for this purpose.

The first object is inventively achieved in a support device having a support plate for the examination subject a supporting unit at which the support plate is movably arranged such that the support plate can be introduced into an opening in cantilever fashion proceeding from one side of the opening, and having a support arranged at that side of the opening lying opposite the supporting unit and on which the support plate while or after passing through the opening can be movably received.

The invention is based on the recognition that, in the case of a large scan length, the support plate introduced in cantilever fashion into the opening sags under the weight of the patient or of the examination subject. Such a sag influences the precision of the image presentation and thus the diagnostic content of a therapy plan. In addition to the sag of the support plate, a tilting of the support plate with respect to the supporting unit can also occur, for example as a result of bearing play.

The invention is also based on the further perception that the recognized sag and tilting should not be avoided by a reinforcement of the support plate since, for example in a computed tomography apparatus, such a reinforcement could lead to an intensified radiation absorption in the support plate under certain circumstances. Moreover, a reinforcement of the support plate would lead to the fact that more foreign material, i.e. material not to be examined, would be introduced into the opening and into the examination region or that this foreign material would at least be introduced in a different geometrical arrangement. As a result, there would be an increased risk of artifacts in the image presentation. If ferromagnetic reinforcing materials were employed, these would have an unwanted influence on the magnetic field of a magnetic resonance apparatus. These disadvantages do not occur with the support device of the invention since a support plate that has already been used can now continue to be used with an increased scan length. The support arranged at the opposite side of the opening can prevent a sag of the bearing plate. Such a support also has the advantage that not only can the support plate left largely unmodified when a greater scan length is desired in an examination apparatus, but also the supporting unit can be substantially unmodified. In the support device of the invention, it is not necessary to retrofit the supporting unit in a costly and/or space-consuming way in order to correct a tilting or a sag of the support plate.

In the support device of the invention, a sag or a tilting of the support plate can be minimized not only for every patient but also can be entirely suppressed. This is especially advantageous since no alteration in the imaging is produced even given different patient loads, extending from the weight of a newborn up to approximately 200 kg.

The term “opening” is employed in a broad sense in conjunction with the invention; this, for example, also includes a recess in a housing. Thus, for instance, a magnetic resonance apparatus having a C-shaped magnet has an “opening” in the inside of the “C” even though this opening is not limited on all sides by the magnet, by a housing or the like.

In a preferred embodiment, the support is a roller or a wheel on which the support plate can be rolled.

Additionally or alternatively, the support has a glide surface for the gliding of the support plate thereon.

In a preferred embodiment, the support has a projection (cantilevered element) pointing in the direction of the opening for the receiving of the support plate. As a result, it is advantageously possible to provide a support for the support plate close to the opening and close to the examination region. The “dead” length, i.e. the non-usable length, of the support plate is thereby reduced. Moreover, it is thus also advantageously possible to position the support at a very slight distance from the opening, i.e. for example, from the gantry of a computed tomography apparatus, without a tilting (intentional) of the gantry that may occur being impeded.

In another preferred embodiment, the support is height-adjustable.

The support is preferably height-adjustable independently of the supporting unit as well as synchronously with the supporting unit.

This height-adjustability is particularly advantageous during operation of the support device of the invention according to the operating method of the invention described below.

The second object is inventively achieved in a method wherein, with the support at a low position, the support plate is conducted through the opening until the support plate resides over the support, and the support is then extended upwardly until the support plate is oriented horizontally.

After achieving a horizontal position of the support plate, the support and the supporting unit are preferably synchronously extended upwardly until the examination subject or, respectively, the patient is positioned at a defined examination height.

### DESCRIPTION OF THE DRAWINGS

FIG. 1 is a side view of a medical examination imaging device having a support device of the invention, with a patient also shown in a position before the examination.

FIG. 2 shows the examination device of FIG. 1, after the patient has been introduced into an opening of the examination apparatus.

FIG. 3 shows the examination apparatus of FIG. 2, after the patient has been brought into a horizontal position using the support.

FIG. 4 shows the examination apparatus of FIG. 3, after the patient has been positioned into a desired examination height.

### DESCRIPTION OF THE PREFERRED EMBODIMENTS

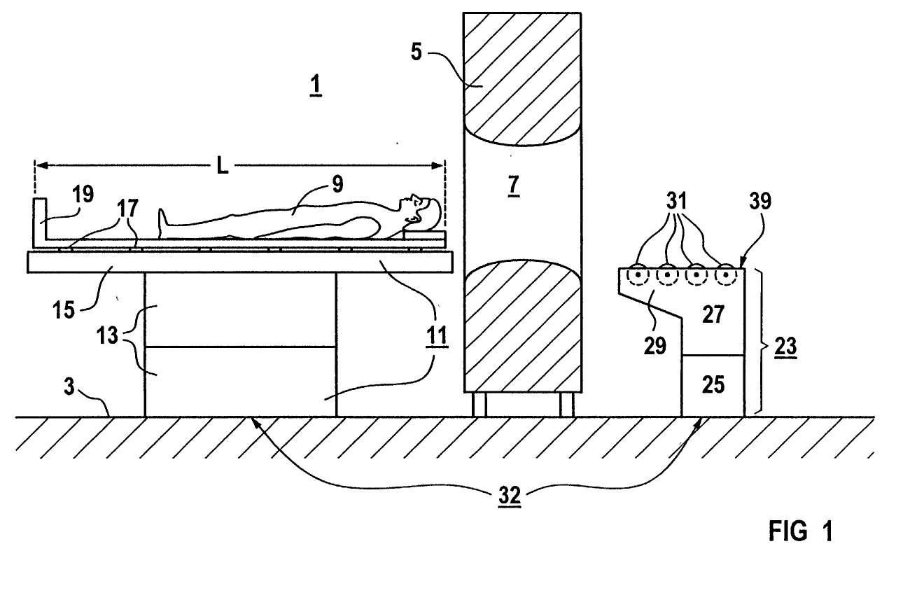

FIG. 1 shows a medical examination imaging apparatus 1, which is a computed tomography apparatus in the exemplary embodiment. The examination apparatus 1 has a gantry 5 standing on a floor 3, shown in cross-section. In a plane perpendicular to the plane of the drawing, an x-ray source that is not explicitly shown rotates on the guide or gantry 5. The gantry 5 has an opening 7 within which the patient 9, introduced into the opening 7, is transirradiated in a specific exposure or examination region.

FIG. 1 shows the patient 9 in a position wherein the examination has been prepared.

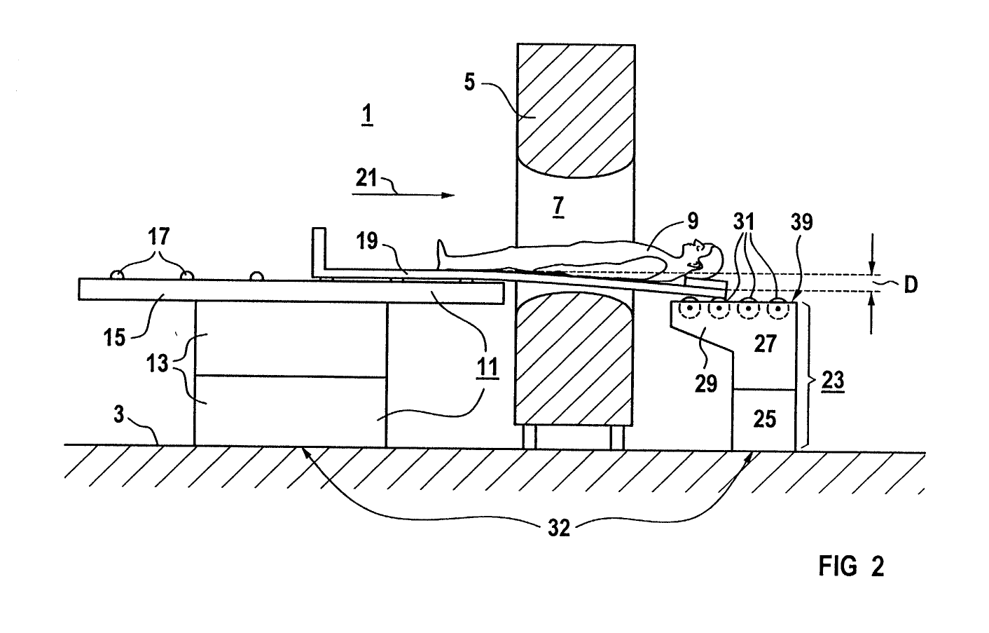

FIG. 1 also shows a supporting unit 11 standing on the floor 3 that has a height-adjustable base 13 and a projecting upper bed part 15 having a number of rollers 17. A support plate 19 is arranged thereon so as to be moveable in the horizontal direction 21 (FIG. 2) on the rollers 17. Due to the horizontal motion 21, the support plate 19 is introduced in cantilever fashion into the opening 7 of the gantry 5 proceeding from the side of the supporting unit 11. A sag D thereby occurs due to the weight of the patient 9.

For correcting or avoiding such a sag D, a support 23 is arranged at that side of the gantry 5 lying opposite the supporting unit 11, the support 23 being composed of a lower part 25 and an upper part 27 with a projection 29. When the patient 9 is conducted through the opening 7, the support 23 is placed in a lowered position relative to the supporting unit 11 such that the support plate 19 together with the patient 9 does not touch the support 23 or—as shown in FIG. 2—slides across it just rolling thereon. FIG. 2 shows the support 23 in its lowest position or standby position. The support plate 19 together with the patient 9 is moved through the opening 7 to such an extent that the support plate 19 has its leading end residing over the front-most roller at the projection 29 of the support 23.

The upper part 27 of the support 23 has a total of four rollers or wheels 31. The rollers 31 are resiliently mounted. In the case of an especially high load due to the weight of the patient, the rollers 31 are pressed under the upper edge of the projection 29. The support plate 19 then glides on the upper edge of the upper part 27 fashioned as a glide surface 39. The glide surface 39 is a low-friction surface, for example composed of a plastic, particularly of polytetrafluoroethylene (Teflon®).

Due to the rollers 31 and/or the glide surface 39, it is possible to place the support plate 19 on the support 23 in a longitudinally movable manner, i.e. with retention of the longitudinal mobility of the support plate 19.

The supporting unit 11 shown at the left in FIGS. 1-4, together with the support 23 shown at the right side of the gantry 5, form a support device 32. The support device 32 of the examination apparatus 1 is thus composed of two components that are constructed overall with less mechanical outlay then would be necessary if only the supporting unit 11 of the left side were present, and would then have to be constructed in a substantially more complicated mechanical way.

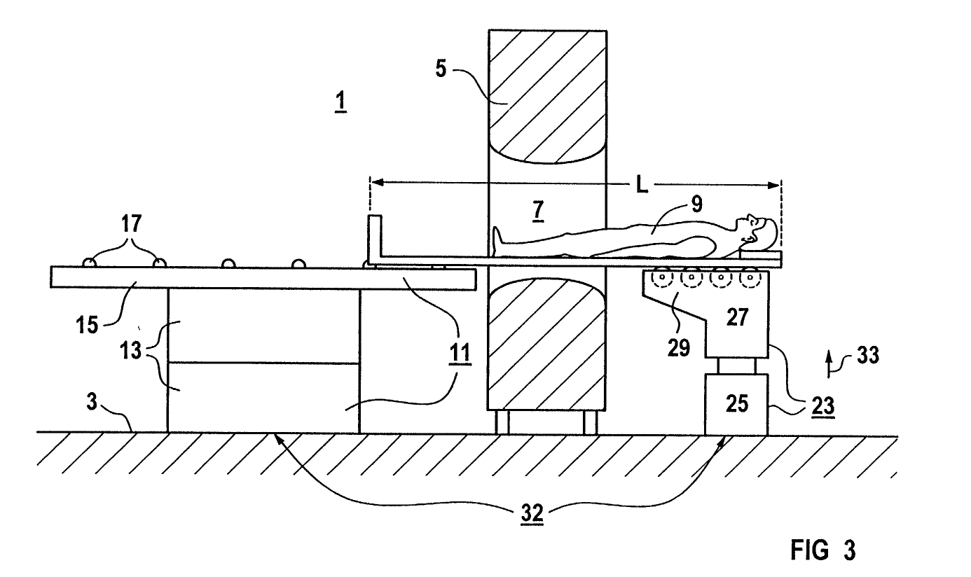

The support 23 is height-adjustable. FIG. 3 shows the support device 32 in a state wherein the upper part 27 is extended relative to the lower part 25 of the support 23 after a height adjustment 33. The supporting device 11 remains unmodified in height given this height adjustment 31. The height adjustment 33 ensues until the support plate 19 resides horizontally. To this end, the support 23 can be fashioned as a motor-driven lifting column with a sensor for position (height) acquisition.

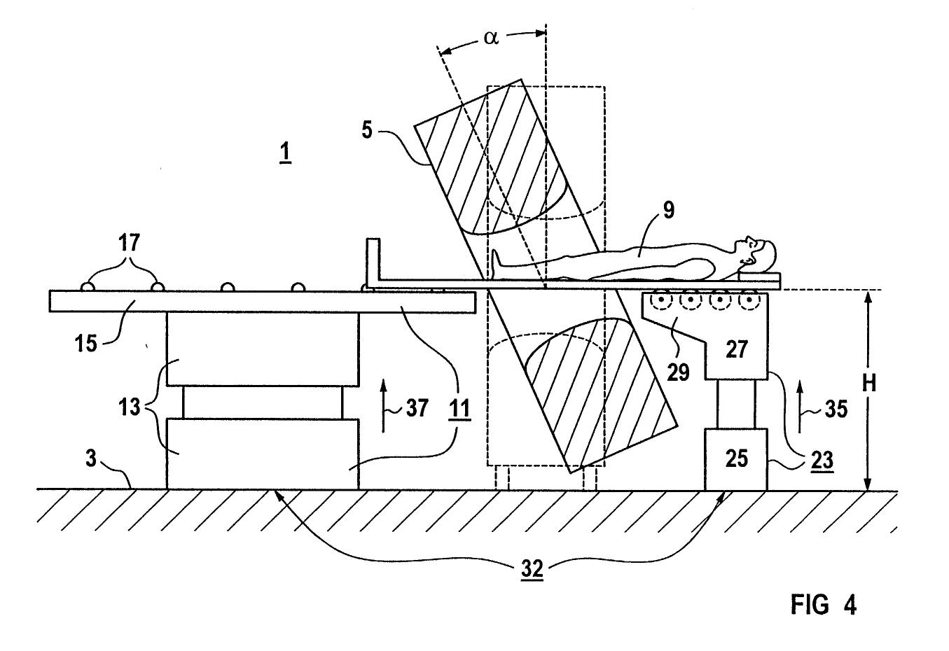

In a following step shown in FIG. 4, i.e. after the horizontal position of the support plate 19 shown in FIG. 3 has been reached, the support 23 and the supporting unit 11 are synchronously extended upwardly, i.e. they move through height adjustments 35 and, respectively 37. The height adjustments 35, 37 are implemented until the patient 9 is positioned at a fixed examination height H. In this way, the examination height H is reproducibly set over the entire length of the patient. The position of the patient 9 is unambiguously defined relative to the gantry 5 regardless of the patient's weight. The independence of the positioning from the weight of the patient 9 is particularly advantageous when the patient 9 is first subjected to an initial examination and is to be subjected to another examination (monitoring examination), for example following tumor therapy that generally leads to a significant loss of weight of the patient.

In the support device 32 of the invention, the support plate 19 is made longer than in known support devices. The length L (FIG. 1) of the support plate 19 (bed board) amounts to approximately 2400 mm and is thus considerably longer then the average patient size to be expected. The upper bed part 15 also is longer than in known support devices. Its length, for example, is in the range from 2000 mm through 4000 mm such as, for example, 3000 mm.

A scan length or examination length of more than 2000 mm thus can be accommodated.

FIG. 4 also shows the gantry 5 in a state wherein it is inclined by an angle a relative to the perpendicular for a special examination. Because the projection 39 extends in the direction of the opening 7, it is assured that the pivotable, lower part of the gantry 5 is not impeded by the support 23 despite the mounting of the support 23 close to the location of the gantry 5.

Although modifications and changes may be suggested by those skilled in the art, it is the intention of the inventor to embody within the patent warranted hereon all changes and modifications as reasonably and properly come within the scope of his contribution to the art.

I claim as my invention:

1. A support device for use with a medical imaging examination apparatus, said examination apparatus having a through opening therein for accepting an examination subject, said support device comprising:
a support plate adapted to receive an examination subject thereon;
a supporting unit on which said support plate is movably mounted for introducing said support plate into said opening in cantilever fashion proceeding from a first side of said opening; and
a support disposed at a second side of said opening, opposite said first side, on which a portion of said support plate after passing through said opening is movably received.

2. A support device as claimed in claim 1 wherein said support has a roller on which said portion of said support plate rolls.

3. A support device as claimed in claim 1 wherein said support has a wheel on which said portion of said support plate rolls.

4. A support device as claimed in claim 1 wherein said support has a glide surface on which said portion of said support plate glides.

5. A support device as claimed in claim 1 wherein said support has a roller and a horizontal glide surface, said roller being resiliently mounted relative to said glide surface so that said portion of said support plate initially rolls on said roller and subsequently glides on said glide surface.

6. A support device as claimed in claim 1 wherein said support has a wheel and a horizontal glide surface, said wheel being resiliently mounted relative to said glide surface so that said portion of said support plate initially rolls on said wheel and subsequently glides on said glide surface.

7. A support device as claimed in claim 1 wherein said support has a projection for receiving said portion of said support plate, said projection extending toward said opening.

8. A support device as claimed in claim 1 wherein said support is height-adjustable.

9. A support device as claimed in claim 8 wherein said supporting unit is height-adjustable, and wherein said support and said supporting unit are height-adjustable synchronized with each other and independently of each other.

10. A method for positioning an examination subject in a medical examination imaging apparatus having a through opening therein, comprising the steps of:
placing an examination subject on a support plate on a height-adjustable support unit disposed at one side of said opening;
mounting a height-adjustable support at a second side of said opening, opposite said first side, for movably receiving a portion of said support plate after said portion of said support plate passes through said opening;
adjusting said support to a low height and conducting said support plate through said opening until a leading end of said support plate is disposed over said support; and
upwardly adjusting the height of said support to simultaneously upwardly move said leading end of said support plate until said support plate is horizontal.

11. A method as claimed in claim 10 comprising the additional step, after said support plate is horizontal, synchronously upwardly adjusting the respective heights of said support and said supporting unit until said examination subject is positioned at a defined examination height.
